(19) United States
(12) Patent Application Publication
(10) Pub. No.: US 2023/0001298 A1
(43) Pub. Date: Jan. 5, 2023

(54) GAME DEVICE AND PROGRAM

(71) Applicant: BANDAI CO., LTD., Tokyo (JP)

(72) Inventors: Erika YASUDA, Tokyo (JP); Yuri OKAMOTO, Tokyo (JP)

(21) Appl. No.: 17/806,178

(22) Filed: Jun. 9, 2022

(30) Foreign Application Priority Data
Jun. 16, 2021 (JP) 2021-100427

(51) Int. Cl. A63F 13/53; A63F 13/24

(52) U.S. Cl. CPC A63F 13/53; A63F 13/24

(57) ABSTRACT

A game is provided that enables a game element to be raised through an intuitive operation input. A game device includes components collectively configured to: execute processing related to the raising game; display the game element; accept an operation input related to raising of the game element; manage the raising phases of the game element; and determine, when a condition for changing from a first raising phase to a second raising phase in the raising game is satisfied, one of branched growing states of the game element related to the second raising phase, in accordance with an operation input related to the raising performed prior to satisfaction of the change condition. The operation input related to the raising includes a first operation input not involving selection of a selection item related to the raising.

### CROSS-REFERENCE TO RELATED APPLICATIONS

This patent application claims priority to Japanese Patent Application JP 2021-100427 filed Jun. 16, 2021, which is incorporated herein by reference in its entirety.

### TECHNICAL FIELD

The present invention relates to a game device and a program, and specifically relates to a game device that provides an electronic game in which a character is raised.

### BACKGROUND

A game device is available that provides a game (raising game) having a raising element in which a character is grown in accordance with operation inputs by a user. JP-A-2020-006054 discloses a game device that provides a raising game in which a parameter referred to as an affection degree to a character is updated in accordance with an operation input performed in response to a randomly occurring event, and a state of the character changes based on the affection degree.

The game device described in JP-A-2020-006054 has physical operation buttons (operation members) serving as a user interface, and an appropriate operation input, uniquely determined for each event, needs to be performed on the buttons to increase the affection degree.

The conventional game device including a limited number of operation members as described in JP-A-2020-006054 employs a scheme under which an appropriate one of a plurality of selection items (options) displayed for each event is selected/determined to guarantee a variety of operation inputs, for preventing the amusement from being limited. For example, when three operation members are provided as in JP-A-2020-006054, two of the operation members are used for changing the selected item, and the remaining one operation member is used for determining the selected item. Thus, an appropriate operation input determined for each event requires an appropriate selection item to be selected from a plurality of selection items displayed for the event, and a determination input to be performed for the selection item.

Unfortunately, the operation input under such a selection scheme is not intuitive, and thus affection of the user to a character may not grow.

An object of the present invention is to provide a game device and a program that provides a raising game enabling a character to be raised through an intuitive operation input.

### BRIEF SUMMARY

A game device according to the present invention is configured to execute processing related to a raising game in which a game element matures, the raising game having a plurality of raising phases defined for the game element, the raising phases including branches for putting the game element in different growing states, and the game device is configured to: execute processing related to the raising game via an executing unit executing via a processor of the game device; display the game element via a displaying unit; accept an operation input, provided via an input interface, related to raising of the game element; manage, via a managing unit executing via the processor of the game device, the raising phases of the game element; and determine, via the processor of the game device, when a condition for changing from a first raising phase to a second raising phase in the raising game is satisfied, one of branched growing states of the game element related to the second raising phase, in accordance with at least one operation input provided via the input interface prior to satisfaction of the change condition, wherein the operation input provided via the input interface prior to satisfaction of the change condition comprises a first operation input not involving selection of a selection item related to the raising.

With the present invention, a raising game can be provided that enables a game element to be raised through an intuitive operation input.

### BRIEF DESCRIPTION OF THE DRAWINGS

FIG. 1 is a diagram illustrating an example of an outer view configuration of a game device 100 according to an embodiment of the present invention.

FIG. 2 is a block diagram illustrating an example of a functional configuration of the game device 100 according to the embodiment of the present invention.

FIG. 3 is a diagram illustrating an example of display on a game screen related to a raising game according to the embodiment of the present invention.

FIG. 4 is a diagram illustrating how a touch input is accepted by the game device 100 according to the embodiment of the present invention.

FIG. 5 is a diagram illustrating an example of a non-selection operation input acceptable in the raising game according to the embodiment of the present invention.

FIG. 6 is a flowchart illustrating an example of friendship degree change processing executed in the game device 100 according to the embodiment of the present invention.

FIG. 7 is a diagram illustrating an example of a data structure of character information used in the game device 100 according to the embodiment of the present invention.

### DETAILED DESCRIPTION

Embodiments will be described below with reference to the attached drawings. The embodiments described below do not limit the invention of the scope of the claims, and not all the combinations of features described in the embodiments are essential for the invention. Two or more of a plurality of features described in the embodiments may be combined in any way. The same or similar components are denoted with the same reference numeral, and will not be redundantly described.

An example embodiment is described below, in which the present invention is applied to a game device configured to be capable of accepting an operation input involving selection of a selection item related to raising in a raising game provided, and an operation input not involving selection of a selection item related to the raising, as an example of a game device. Still, the present invention is applicable to any devices capable of at least accepting the latter operation input.

«Configuration of Game Device»

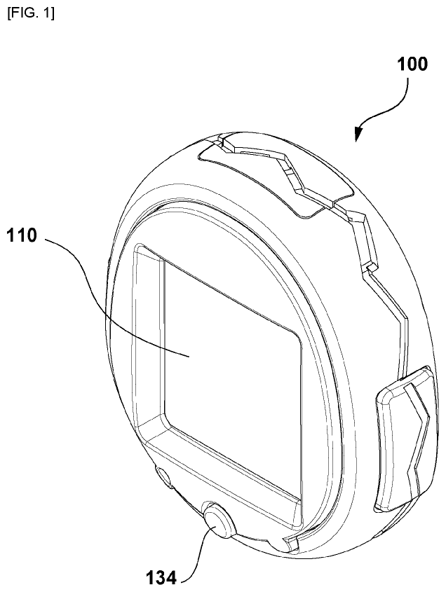

FIG. 1 is a diagram illustrating an example of an outer view configuration of a game device 100 according to this embodiment. As illustrated in the figure, the game device 100 includes a display unit 110 that displays a game screen related to a raising game as described below, and a physical operation member 134 that accepts an operation input from a user. In this embodiment, the display unit 110 is configured to be capable of accepting a touch input, and includes a touch panel sensor 131 for detecting the touch input.

<Functional Configuration of Game Device>

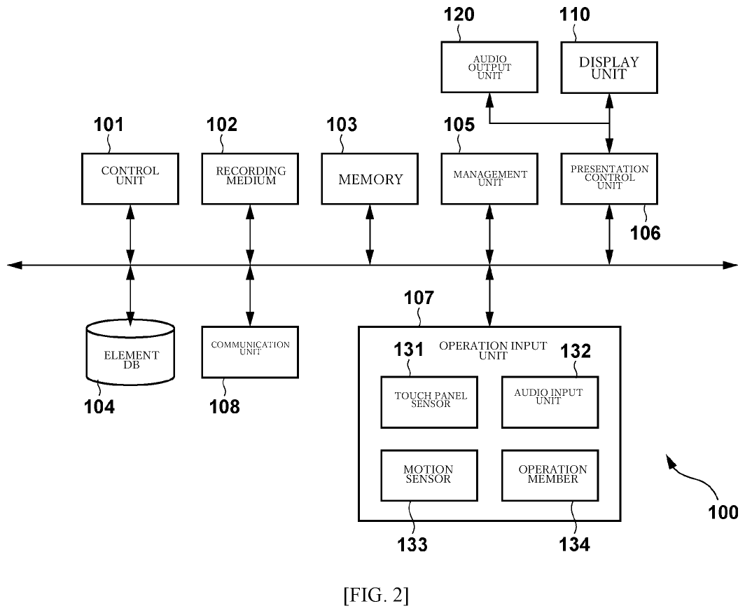

Now, a functional configuration of the game device 100 according to this embodiment is described with reference to a block diagram in FIG. 2.

A control unit 101 is, for example, a central processing unit (CPU) and controls operations of the blocks of the game device 100. Specifically, the control unit 101 reads an operation program for the blocks recorded to, for example, a recording medium 102, loads the operation program to a memory 103, and executes the operation program to thereby control operations of the blocks.

The recording medium 102 is, for example, a recording device, such as a nonvolatile memory or a hard disk drive (HDD), capable of retaining data in a substantially permanent manner. To the recording medium 102, parameters necessary for operations of the blocks, various rendering elements (images of a character and an item, graphical user interfaces (GUIs) and background images) used in the raising game of this embodiment, an action determination program, and other information are recorded in addition to the operation program for the blocks of the game device 100. The recording medium 102 is not limited to a built-in recording device of the game device 100, and may include an external recording device detachably attached to the game device 100 for example. The memory 103 is, for example, a recording device, such as a volatile memory, used to temporarily store data. The memory 103 is used not only as a loading area for the operation program for the blocks but also as a storage area for temporarily storing data, etc. output in the operations of the blocks.

An element DB 104 manages information on various game elements in the raising game that provides a play experience in the game device 100. The raising game of this embodiment relates to game content in which a character is raised. The element DB 104 includes information (character information) on each character that can be raised. As will be described in detail below, in the raising game, a mode (growing state) of a raising target character (target character) gradually changes to express the growth of the character, and the character information is configured for each growing state, to be managed in the element DB 104. Thus, the raising game provides a play experience related to the raising of a single target character, and is executed with reference to character information varying among growing states during the play experience.

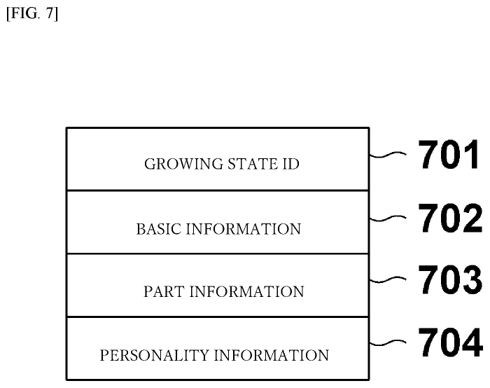

For example, as illustrated in FIG. 7, character information managed for a single growing state may include, in association with a growing state ID 701 uniquely identifying the growing state: basic information 702 indicating the gender, the name (classification), and the like of a character according to the growing state; part information 703 identifying various part sets (character images and part images) used for forming the outer view of the character according to the growing state; and personality information 704 defining tendency/preference regarding how the character acts and thinks according to the growing state.

The element DB 104 may manage item information of an item usable in the raising game including the effects of the item and the like, in addition to the character information.

A management unit 105 manages changes in the growing state of the target character. As described above, the progress of the raising game involves a change in the growing state of the target character, and how the growing state transitions is not fixed. Instead, the transition of the growing state occurring in the course of the growth changes in accordance with the progress state of the raising game, to provide various amusing elements regarding the raising experience. As will be described in detail below, a single raising step of the target character is provided with a plurality of raising phases. When transitioning between raising phases, the management unit 105 determines which growing state is appropriate for the target character. The growing state is determined based on determination of whether the progress state of the raising game satisfies a predetermined growth enabling condition for each growing state.

A presentation control unit 106 is responsible for controlling presentation, to the user, of various types of information in the game device 100. It is assumed that the game device 100 of this embodiment includes the display unit 110 that displays images (game screens, menu screens, etc.) and an audio output unit 120 that outputs sounds as means for presenting various types of information to the user, and a description is given; however, the means for presenting information is not limited to these, and vibration, illumination, information transmission, etc. may be used as a substitute or an addition, as a matter of course.

The presentation control unit 106 includes, for example, a drawing device, such as a drawing chip, and performs a predetermined drawing process when a game screen to be displayed on the display unit 110 is generated. Specifically, the presentation control unit 106 generates a game screen that corresponds to the progress state of the game and refreshes the display shown on the display unit 110 with a predetermined frequency during a period in which the game device 100 is not in a sleep state to thereby present various types of information concerning the raising game. In the raising game that provides a play experience in the game device 100 of this embodiment, a game screen on which the target character is arranged is basically presented so as to allow the user to know the state of the target character. Therefore, based on the growing state of the target character at the timing when being displayed, the presentation control unit 106 reads from the recording medium 102 and loads to the memory 103 rendering elements specified by the part information 703 in the character information of the growing state, and uses the elements to draw the target character. Further, the presentation control unit 106 controls rendering so as to arrange an appropriate background or item as needed or display a GUI on the game screen in accordance with the progress state of the game.

In accordance with one embodiment, the game device 100 has a toy body that can be easily carried by the user, and the display unit 110 is a display device, such as a liquid crystal display (LCD), that is built in the game device 100 and is formed in an integrated manner, and a description is given; however, embodiments of the present invention are not limited thereto. That is, the display unit 110 may be a display device that is externally connected to the game device 100 so as to be detachable and re-attachable, as a matter of course.

The presentation control unit 106 includes, for example, a circuit, such as a sound chip, that outputs an audio signal, and performs a predetermined process when generating sounds to be output from the audio output unit 120. Specifically, the presentation control unit 106 determines a piece of audio data, among pieces of audio data recorded in advance to the recording medium 102, to be output in accordance with, for example, the progress state of the game, converts the piece of audio data to an electrical audio signal (performs D/A conversion), and outputs the audio signal to the audio output unit 120 to thereby perform audio presentation concerning the raising game. The audio output unit 120 may be a predetermined speaker, etc. and outputs an acoustic wave based on the input audio signal. In this embodiment, it is assumed that the audio output unit 120 is built in the game device 100 similarly to the display unit 110, and a description is given; however, the audio output unit 120 may be externally connected to the game device 100 so as to be detachable and re-attachable.

An operation input unit 107 is a user interface, such as an operation button, of the game device 100. When detecting an operation input performed by the user, the operation input unit 107 transmits a control signal corresponding to the operation to the control unit 101. The user interface of the game device 100 of this embodiment includes, in addition to the physical operation member 134 that forms a part of the outer view of the game device 100 and is configured to enable a pressing operation by the user, the touch panel sensor 131 for detecting a touch input on the display unit 110, an audio input unit 132 (such as a microphone, for example) for detecting an audio input performed by the user, and a motion sensor 133 (such as an acceleration sensor or a gyro sensor, for example) for detecting a motion of the user carrying the game device 100. In this embodiment, the motion sensor 133 detects, as the operation input, a walking motion (the number of steps) of the user carrying the game device 100, for example.

A communication unit 108 is a communication interface of the game device 100. Although not elaborated in this embodiment, the game device 100 is connected to and is configured to be capable of transmitting and receiving information to and from an external device such as another game device 100 and other information communication terminals, using the communication unit 108.

«Game Overview»

An overview of the raising game that provides a play experience in the game device 100 of this embodiment having the configuration described above will be described below.

As described above, the raising game is game content in which a target character that is a game element according to the present invention is raised, with a screen including display of the target character presented as a basic game screen. In the raising game, the target character grows and/or matures while transforming from one growing state to another each time the raising phase transitions, and the user can observe the growth of the character on the game screen.

This “raising phase” is a concept indicating each of multiple phases (egg period (before birth), baby period (infant period), kid period (child period), young period (adolescence period), friend period (adult period), etc.) into which the process (period) of growth of the target character in the raising game is divided, and transitions between raising phases occur when a condition such as a raising elapsed time is satisfied. The “growing state” is a concept defining the type/form of the character in the raising game. The target character is in any of the growing states in each raising phase. One or more types of growing states are defined for each raising phase. As described above, the management unit 105 manages the growing state of the target character in accordance with the progress state of the raising game. For example, in the raising game according to one aspect, the target character before birth is in a form of an egg, which is of a single type. The growing states provided for the target character may include: two types of forms for each gender in the infant period after the birth (after the hatching); two types of forms for each gender (a total of four types) in the child period; three types of forms for each gender (a total of six types) in the adolescence period; and five types of forms for each gender (a total of 10 types) in the adult period. Thus, a change from one raising phase to the next raising phase involves a transition along a branched portion of relationships between the various growing states of the target character With the types of the growing states onto which the character can be grown thus increasing with the progress of the raising phase, the variety and amusement of the game can be increased. For example, from a first raising phase, the character may grow/mature along one and only one of a plurality of growing states. Once a growing state is determined for growth/maturity from the first raising phase, the character cannot switch to a different growing state, and thereby the various growing states form a branched relationship relative to one another, as a plurality of growing states are available from a single raising phase. At each raising phase, a different plurality of growing states may be available, again in a branched relationship to one another, so as to provide a desirable variety of available pathways for growth/maturity of a character within the game.

In the raising game of this embodiment, an operation input related to raising the character is utilized for determining the appropriate growing state for the character when the raising phase change condition is satisfied. Thus, while the raising game progresses, the management unit 105 manages a predetermined parameter changing in accordance with the operation input made in relation to the raising of the target character, and refers to the parameter as appropriate when the raising phase changes. More specifically, when the change condition from the first raising phase to the second raising phase is satisfied, the management unit 105 refers to the corresponding parameter reflecting the operation input made prior to satisfaction of the change condition, and determines an appropriate one of the plurality of branched growing states corresponding to the second raising phase, for application to the target character after the first raising phase (such that the target character transitions to the appropriate one of the plurality of branched growing states upon satisfaction of the change condition). In this embodiment, the predetermined parameter includes a “friendship degree” of the target character (regarding the user), and “history of raising actions (history of care taking)” performed on the target character by the user. Hereinafter, a detailed description will be given on how these parameters are updated based on the operation input for changing the parameters and on the determination on the operation input.

<Friendship Degree>

The friendship degree is an index indicating how much the user has interacted with the target character to perform activities related to the raising of the target character. The friendship degree is reflected as a numerical value in the raising game, indicating the level of trust of the target character toward the user, or how much affection from the user the target character is feeling. A positive numerical value is added to the friendship degree when the operation input related to the raising action is determined to be favorable, and 0 or a negative numerical value is added when the operation input is not determined to be favorable. The management unit 105 manages the friendship degree while the raising of the target character is in progress.

In the raising game of this embodiment, the following two types of operation inputs are received as an operation input for changing the friendship degree.

(Selection Operation Input)

The first type of the operation input is an operation input (hereinafter, referred to as a selection operation input) involving selection of a selection item related to the raising action. This is referred to as a second operation input in the present invention. More specifically, the selection operation input is performed by placing any of one or more selection items presented into a selected state, and by making a final confirmation on the selection item that has been placed in the selected state. This selection operation input is used when the user checks a state (including a state of health of the target character, a state of an environment (room) where the target character resides, and a raising state of the target character) of the target character presented using the display unit 110 and the audio output unit 120, and selects a raising action anticipated to be favorable for the state among executable actions (selection items).

Examples of the selection operation input may include the following actions for the target character:

giving an item (selecting an item to be given from possessed items);

instructing an action to be performed (selecting an action to be performed from executable actions); and

executing a treatment for changing the state (selecting a treatment to be executed among executable treatments).

Specifically, the selection operation input is used for selecting from a menu, including meal, snack, and the like, and giving the selected item to the target character in a hungry state, for example. Furthermore, the selection operation input is used for making the target character take an action such as bathing and cleaning, when the target character is dirty or the room is dirty, for example. Furthermore, the selection operation input is used for performing treatment on the target character in a sick state, for example. In this case, the friendship degree is incremented or decremented depending on whether a favorable raising action has been selected by the selection operation input. For example, the friendship degree is incremented or decremented depending on whether the item given was appropriate, whether the item given has met the preference of the target character, whether the target character has turned into a favorable state as a result of bathing, and whether the target character has turned into a favorably healthy state as a result of the treatment (the friendship degree is incremented when the result is favorable, and is decremented when the result is unfavorable).

The selection operation input is not limited to a case where the user spontaneously checks the state of the target character and selects the raising action. For example, the selection operation input is similarly used in a case where a raising action is selected for an event, triggered by a request from the target character, occurring randomly while the raising game is being provided (care-requiring event).

As described above, any of the selection operation inputs is an operation input made on a GUI (selection item) related to selection of a raising action, and serves as an indirect operation input on the target character. Thus, the selection operation input does result in an extensive lineup of types of the selection items to contribute to the variety of the raising game on one hand, but may also make the user feel distant from the target character in terms of the raising of the target character on the other hand.

The selection operation input is not limited to that made using the operation member (e.g., a button provided to have a physical shape of the operation member 134). The selection operation input may be configured to enable input of selection and confirmation of selection items provided in tiers for example (such as switching of displayed selection items through a swipe operation (page turning), confirmation made when a tapping operation continues for a predetermined period of time or more (long pressing operation), etc.), in accordance with the touch input detected through the touch panel sensor 131 or with the touch input further included. In the raising game of this embodiment, input control is performed on the selection operation input in such a manner that a selection item is started to be displayed when the operation input to the operation member 134 is detected, the selection item displayed is changed in response to a swipe operation, and in response to the long pressing operation on the selection item displayed, a raising action corresponding to the selection item is executed or a selection item subordinate to the selection item is displayed.

(Non-Selection Operation Input)

On the other hand, the second type of the operation inputs is an operation input (hereinafter, referred to as a non-selection operation input) not involving selection of any selection item related to a raising action. This is referred to as a first operation input in the present invention. More specifically, the non-selection operation input is an operation input to which the target character reacts directly (and the reaction is presented to a user as a result of the non-selection operation), without involving an operation a sequence of displayed menus or selections, such as a sequence of display→select→confirm of a selection item as in the case of the selection operation input described above regarding the raising action. The non-selection operation input is used in a situation where a real-time raising action is required, such as calling and physically interacting with the target character. In other words, the non-selection operation input is used for providing an interactive play experience of the raising game, with which the user is more likely to deepen his or her affection toward the target character.

The non-selection operation input with such a characteristic of directly affecting the target character requires dynamic processing of the operation input detected, and presentation of the reaction from the target character. Thus, compared with the selection operation input involving execution of processing corresponding to the selection item selected in response to the operation input for the final confirmation and presentation of the reaction of the target character, the processing for the non-selection operation input may involve a large amount of calculation and power consumption. In view of this, the game device 100 of this embodiment is configured to accept the non-selection operation input only during a period in which the game device 100 is in a communication mode as a result of transition from a normal mode.

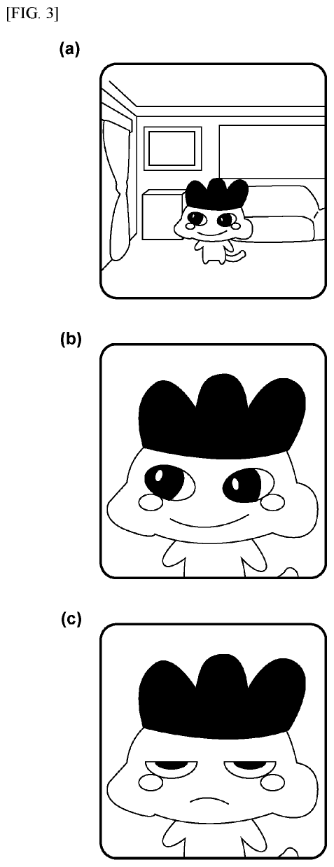

In this embodiment, a description is given assuming that the transition to the communication mode is triggered by a touch input on a region of the target character in the game screen. For example, in a state where the transition to the communication has not occurred, a game screen simply showing the target character in a room is presented as illustrated in FIG. 3A. On the other hand, in a state where the transition to the communication mode has occurred, as illustrated in FIG. 3B or 3C, basically, a game screen is presented that shows the target character that has approached toward the user to be in a face-to-face state, in accordance with an operation input (the touch input on the region of the target character and an audio input related to the first phase described later) from the user.

As illustrated, in the communication mode, the target character is displayed as having a face that is displayed larger than the target character's face displayed in the normal mode, so that the user can sense subtle changes of the target character, and so that an easy touch input is guaranteed for some of the communication types described below. The facial expression of the target character is controlled based on the friendship degree, to express how much love from the user the target character is feeling. For example, the facial expression of the target character may be determined through comparison between the friendship degree and a predetermined threshold, during the transition to the communication mode. Specifically, when the friendship degree exceeds the predetermined threshold (happy), the target character is controlled to have a relaxed look as illustrated in FIG. 3B. On the other hand, when the friendship degree is lower than the predetermined threshold (not happy), the target character is controlled to have a cold look as illustrated in FIG. 3C.

Under the communication mode of this embodiment, the non-selection operation input is accepted in the following two phases, so that communications with the target character seem more natural.

When the touch input is performed on the region of the target character, acceptance of the non-selection operation input in the first phase starts. The non-selection operation input accepted in the first phase is an audio input using the audio input unit 132, and is detected only for a predetermined period (10 seconds, for example). When any audio input is made during the period, the user is assumed to have called the target character, and transition of the communication mode to the second phase is confirmed for further acceptance of the non-selection operation input. In this process, the display on the game screen sequentially transitions, in response to the audio input made, to present the target character, with the facial expression corresponding to the friendship degree, approaching to be in the face-to-face state as illustrated in FIG. 3B or 3C, from the monitored state as illustrated in FIG. 3A. On the other hand, when no audio input is made during the period, the user is assumed to have not called the target character, and the communication mode ends. Thus, the transition to the normal mode occurs.

When the transition to the second phase is confirmed, a type of communication with the target character is determined, and then the transition to the second phase occurs to accept the non-selection operation input of the type determined. In the raising game of this embodiment, types of the communication according to the second phase include a “caressing mode” of touching the target character and a “listening mode” of listening to what the target character has to say, involving communications based on a touch input and a motion input, respectively. The type of communication may be determined through random selection of one of these types, or determined based on the type of the first non-selection operation input made after the transition to the second phase was confirmed. Alternatively, the user may determine which of the types of communication he or she uses to communicate.

The above-described limitation on the type of communication related to the acceptance of the non-selection operation input in the second phase is a mode for a simple purpose of reducing the amount of calculation and power consumption in the game device 100, and it should be easily understood that such a mode does not limit the embodiment of the present invention. Specifically, in an embodiment where the control unit 101 has a sufficient arithmetic capacity and where the game device 100 has a large capacity battery, the type of the non-selection operation input accepted in the second phase may not be limited.

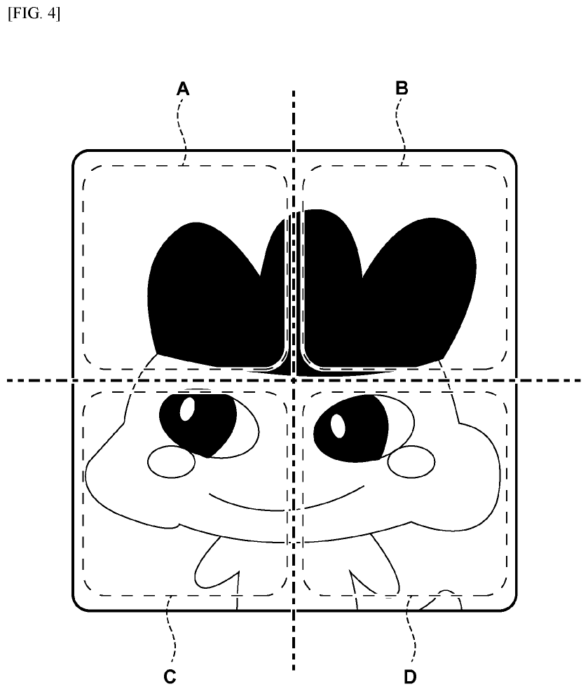

In the “caressing mode,” the friendship degree is incremented or decremented depending on what kind of touch input the user performs on the target character displayed in the face-to-face state. As described above, in the game screen displayed during the transition to the communication mode, the target character is displayed to be enlarged, so that the user can easily perform various touch inputs to physically interact with the target character. In this embodiment, a game screen including the target character in the face-to-face state as described in FIG. 4 is divided into four regions (A to D), and a physical communication action (raising action) performed by the user on the target character is identified based on the transition of the touch input on these regions, and the behavior control and a change in the friendship degree are performed for the target character accordingly.

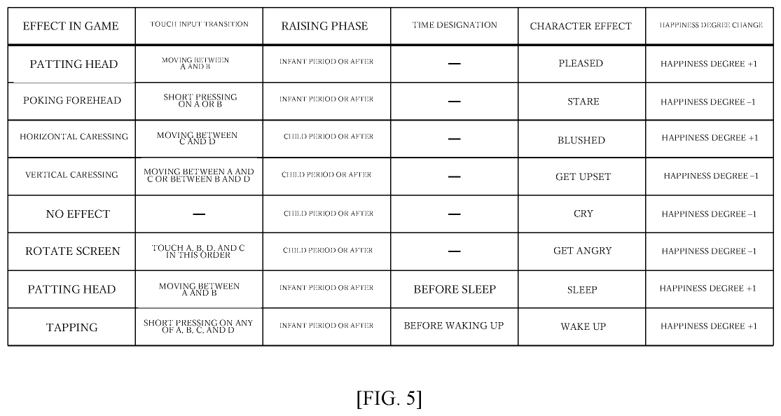

The types of non-selection operation inputs (a series of touch inputs) acceptable in the “caressing mode” may be determined as in a table illustrated in FIG. 5, for example. As illustrated, each non-selection operation input is defined by a series of touch inputs (transition of the region where a touch input is detected) intuitively corresponding to the relevant operation. When the non-selection operation input is performed, a corresponding effect is displayed (the display mode of the target character changes) and the friendship degree is incremented/decremented. Here, to express an increase in the variety of reactions against the user with the growth of the target character, in the raising game of this embodiment, the raising phase in which each non-selection operation input is acceptable is defined.

Some of the non-selection operation input may be configured to be acceptable at a limited timing. In the raising game of this embodiment, the non-selection operation input can be used for supporting the target character falling asleep or waking up at the time before the target character sleeps and wakes up, to make the user recognize that he or she is raising the target character, which is a single living being. The time before the target character sleeps and wakes up may be determined with designated time points, and the corresponding non-selection operation input may be controlled to be acceptable when the clock set for the game device 100 indicates that such a time point has arrived.

For example, when the bedtime is set to a designated time point of 20:30, control may be performed in such a manner that the internal clock indicating 20:00 triggers a bedtime event involving a bedtime effect, and forcible transition to a state where the non-selection operation input is accepted occurs as in the “caressing mode.” The bedtime effect may include: starting notification indicating that the target character is having hard time falling asleep; and showing the target character starts to be drowsy and gradually falls into sleep in response to an appropriate non-selection operation input (touch input going back and forth between the regions A and B, related to “before sleep” as illustrated in FIG. 5), for example. The number of times the non-selection operation input needs to be performed until the target character falls asleep may be randomly determined to express the reality of a living being. The friendship degree may be changed when an appropriate non-selection operation input continues from the start to the end (when the target character falls asleep) of the bedtime event. As described above, in a time designated event such as those before sleep or waking up, control may be performed in such a manner that a single relevant non-selection operation input would not change the friendship degree, but the non-selection operation input performed for multiple times results in a change in the friendship degree to express the reality of the living being of the target character.

In particular, when the non-selection operation input related to the touch input is accepted through transition of the touch input among the four divided regions as in this embodiment, the types of non-selection operation inputs acceptable for the target character are limited. In view of this, the same type of non-selection operation input may be determined as an appropriate input for the “caressing mode” and for a time designated event as illustrated in FIG. 5. Specifically, control may be performed in such a manner that the same non-selection operation input results in the friendship degree changing differently between the “caressing mode” and the time designated event.

On the other hand, under the “listening mode,” a text (words) corresponding to the history of the motion input made by the user carrying the game device 100 is presented as a message from the target character, and the friendship degree is incremented. More specifically, information (the number of steps) on walking by the user carrying the game device 100 is accumulated in the memory 103, and when the number of steps satisfies a condition related to the message presentation at the time of the transition to the “listening mode,” processing of presenting the message and incrementing the friendship degree is executed, for example. Whether the condition related to the message presentation is satisfied may be determined based on the history of the number of steps within a predetermined period, such as the number of steps detected on the day, and not on the accumulated number of steps. When the condition related to the message presentation is not satisfied, display control for ending the “listening mode” without changing the friendship degree (ending the communication mode and transitioning to the normal mode) may be performed.

In this embodiment, for the sake of easy understanding of the invention, a description is given assuming that only a message related to the non-selection operation input (motion input) is presented under the “listening mode.” However, the embodiment of the present invention is not limited thereto. Specifically, for the sake of increasing the affection of the user toward the target character, under the “listening mode,” a message not based on the non-selection operation input may be presented. For example, a question message from the target character related to the preference of the user, a message related to an answer to a question, a message corresponding to the raising action performed so far and the current friendship degree, or the like may be presented.

In this embodiment, a description is given assuming that the friendship degree is changed based on the history of the motion input when transition to the “listening mode” occurs, to prioritize the communications between the user and the target character. However, the embodiment of the present invention is not limited thereto. Specifically, the friendship degree may or may not be changed based on the motion input prior to or after the transition to the “listening mode” for clearly notifying the user of the increment of the friendship degree (performing feedback). An embodiment may be employed in which the friendship degree is changed without performing the feedback, when the motion input history satisfies a predetermined condition.

In this embodiment, a description is given assuming that, to make the communications with the target character seem more natural, under the communication mode, a non-selection operation input related to an audio input is accepted in the first phase, and the non-selection operation input related to a touch input or a motion input, that is, a non-selection operation input of a type different from that accepted in the first phase is accepted in the second phase. However, the embodiment of the present invention is not limited thereto. Specifically, the type of the non-selection operation input accepted in the multiple phases under the communication mode is not limited to this embodiment, and the type of the non-selection operation input accepted in the later phase does not need to be different from that of the non-selection operation input accepted in the earlier phase. Furthermore, an embodiment may be employed in which the friendship degree is changed directly in response to the non-selection operation input (first phase) performed after the transition to the communication mode, instead of changing the friendship degree through acceptance of non-selection operation inputs in multiple phases.

As described above, in the raising game of this embodiment, the friendship degree of the target character toward the user is incremented or decremented in response to two types of operation inputs that are the selection operation input involving selection of a selection item related to the raising and the non-selection operation input not involving selection of a selection item. The operation inputs may be treated differently in the raising game based on the following points, instead of being based on whether they involve the selection of a selection item, for the sake of increasing the affection of the user toward the target character.

As the first point, while the selection operation input involves presentation of a selection item that includes a raising action favorable for the state of the target character, it might be difficult for the user to recognize the non-selection operation input with which the friendship degree is incremented. In view of this, a change in the friendship degree caused by the non-selection operation input of each type may be the same among the growing states of the target character. In this case, for the sake of higher amusement, control may be performed to make a change in the friendship degree, in response to the selection operation input, different among the growing states of the target character, and depending on the preference (of the target character) (for example, a change in the friendship degree in response to giving an accessory C may differ between growing states A and B).

As another point, the direct reaction from the target character against the operation input as in the communication mode is more likely to increase the user's affection toward the target character. In view of this, a configuration may be employed in which the number of opportunities for changing the friendship degree through the non-selection operation input, that is, the number of opportunities for transitioning to the communication mode is unlimited in the course of the raising game, but the number of opportunities for changing the friendship degree through the selection operation input is limited based on the number of items possessed, the number of purchasable items, the frequency of occurrence of the care-requiring event, and the like. Thus, the raising game of this embodiment is configured with the acceptable number of selection operation inputs related to the raising set, but without the acceptable number of non-selection operation inputs related to the raising set. As a result, it is possible to induce the user to actively perform the raising action related to the non-selection operation inputs, to increase the friendship degree. Furthermore, since opportunities for increasing the friendship degree through the non-selection operation input are more effectively guaranteed, raising of the target character to have a desired friendship degree can be facilitated.

The friendship degree also serves as an index indicating the affection degree of the user toward the target character and how much he or she has taken care of the target character. Thus, when a state where the friendship degree is low continues for a while, for example, the user is preferably notified of the low friendship degree, and the user is induced to engage in a gameplay through which the user can better enjoy the amusement of the raising game. For example, if the game progresses without any problem through a gameplay implemented with minimum operations such as feeding, and without requiring the use of the communication mode and other kind of care taking, the user may be less likely to feel affection to the target character, and the raising game may fail to amuse the user. In view of this, in the raising game of this embodiment, when a state where the friendship degree falls below a threshold (such as −20) continues for a predetermined period of time (such as 72 hours), an effect (preparation for leaving home) starts to be presented in which the target character chooses to disappear from the game device 100 (leaving the home: the target character is no longer raisable, and the raising game related to the target character ends). Here, a configuration is employed where about an hour of grace period is provided for preparation to leave home (prior to the character actually leaving the home), so that the user can stop the preparation for leaving the home by performing an operation input to make the target character rethink whether to leave the home, when such an effect is presented. Thus, the effect of preparation for leaving the home is presented to draw attention of the user to notify the user that the progress of the raising game is at risk, and then an opportunity for getting out of such a situation is provided. Thus, the user can be induced to review his or her attitude toward the target character, to implement a gameplay through which he or she is more likely to enjoy the amusement of the raising game.

The non-selection operation input under the communication mode or the like enabled for the leaving home effect may conflict with the action of the target character. In view of this, control is performed in such a manner that only the selection operation input for making the target character rethink its decision to leave home is able to be accepted when an occurrence condition for the leaving home effect is satisfied. In other words, control is performed in such a manner that the non-selection operation input is unable to be accepted under such a condition. As described above, the number of times the non-selection operation inputs related to the raising is acceptable during the course of the raising game is not limited. Still, it is a matter of course that this does not apply to the condition where the target character is preparing to leave home or has left the home. In other words, in the raising game of this embodiment, the number of times the non-selection operation input related to the raising is acceptable is not limited under a normal condition where the target character is not preparing to leave home or has not left the home.

When the change condition in each raising phase is satisfied with the friendship degree thus determined, in the raising game of this embodiment, the growing state of the target character related to the raising phase after the change is determined. More specifically, for each of a plurality of types of branched growing states for the raising phase after the change, a range of the friendship degree required for proceeding to the growing state is determined. The management unit 105 determines the growing state after the change, depending on which of the ranges includes the friendship degree at the timing when the change condition is satisfied. Furthermore, to increase the amusement related to the raising of the target character, for example, for a predetermined raising phase (such as an adult period, which is the final raising phase) or after, the management unit 105 may determine the growing state after the change based not only on the friendship degree but also on the history of the raising action such as the number of successful care-requiring events and the type of an item given.

To present a further amusement element to a user implementing a gameplay with a particularly high affection to the target character, the raising game may include a special effect only presented when the maximum friendship degree is achieved. A determination of whether to present the special effect may be made during each raising phase, and when the target character transitions through a plurality of raising phases while maintaining the maximum friendship degree, the special effect may be presented in each of the raising phases. The special effect may be about giving a predetermined item in the raising game such as a badge or an icon. Such an item may serve as a collection element to be a goal achieved in a repeated gameplay, whereby the user can be lured to a gameplay with a higher level of amusement. In this context, the raising game of this embodiment is configured to enable new characters to be raised one after another, using an egg acquired through marriage, childbirth, or the like for example, with a plurality of types of characters that can be the target character one after another provided (configured to enable a repeated gameplay with the raising target character sequentially changing). Thus, the predetermined item given may differ among the types of the character raised.

«Friendship Degree Change Processing»

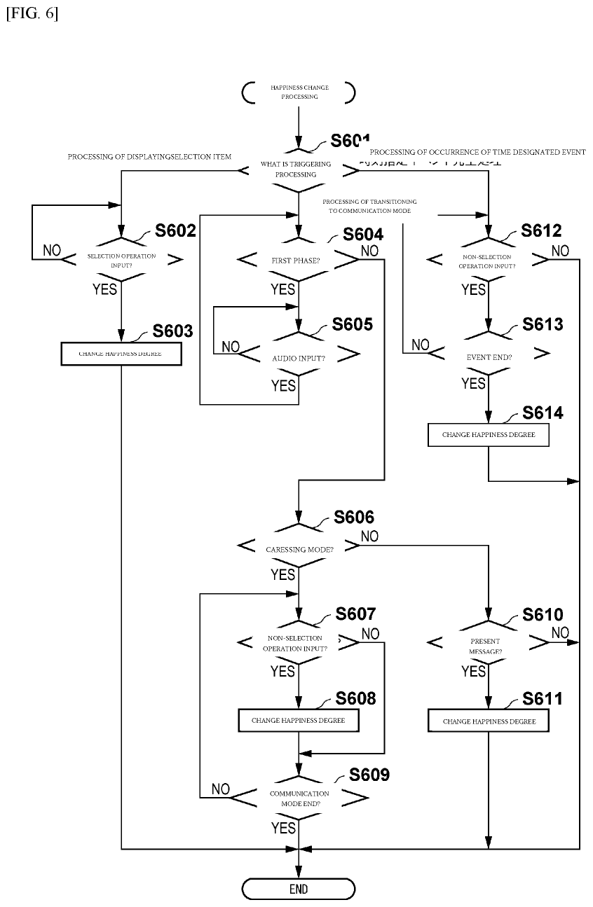

The friendship degree change processing executed for changing the friendship degree in the game device 100 of this embodiment having the configuration as described above will be described in detail with reference to a flowchart in FIG. 6. The processing corresponding to the flowchart can be executed by the control unit 101 reading a corresponding processing program stored in the recording medium 102, loading the program onto the memory 103, and the executing the program, for example. Note that a description will be given assuming that the friendship degree change processing starts when processing determined to be related to a change in the friendship degree (processing of displaying a selection item related to the raising action, processing of transitioning to the communication mode, and processing regarding the occurrence of a time designated event) is executed, for example.

In S601, the control unit 101 determines which of the types of the processing has triggered the friendship degree change processing. The control unit 101 advances the processing to S602 upon determining that the processing has started based on the processing of displaying a selection item related to the raising action, advances the processing to S604 upon determining that the processing has started based on the processing of transitioning to the communication mode, and advances the processing to S612 upon determining that the processing has started based on the processing regarding the occurrence of a time designated event.

In S602, the control unit 101 determines whether a selection operation input is performed on one selection item. The control unit 101 advances the processing to S603 upon determining that the selection operation input has been performed on one selection item, and repeats the processing in S602 upon determining that the input has not been made. The control unit 101 ends the friendship degree change processing, when a predetermined timeout period elapses with no selection item selected. Here, the friendship degree may be decremented due to caring failure in a case where the processing is executed for an event requiring an operation input from the user (selection of a selection item), such as a case where the processing of displaying the selection item related to the raising action, which has triggered the change processing, is executed in response to the care-requiring event, for example.

In S603, the management unit 105 changes the friendship degree of the target character in accordance with the selection item selected in S602 under the control by the control unit 101, and the friendship degree change processing ends. The friendship degree may be changed to be incremented by a predetermined value when a favorable selection item is selected through the selection operation input for example, or to be decremented by a predetermined value when an unfavorable selection item is selected through the selection operation input for example. As described above, whether the selection item selected is favorable may be comprehensively determined based not only on the status of the target character but also on the corresponding personality information 704 such as the preference of the target character.

Upon determining that the friendship degree change processing is executed in response to the processing of transitioning to the communication mode in S601, the control unit 101 determines whether the phase of the non-selection operation input acceptance is the first in S604. The control unit 101 advances the processing to S605 upon determining that the phase of the non-selection operation input acceptance is the first, and advances the processing to S606 upon determining that the phase is the second or after.

In S605, the control unit 101 determines whether the non-selection operation input related to the audio input has been made. The control unit 101 stops the acceptance of the non-selection operation input in the first phase and returns the processing to S604 upon determining that the non-selection operation input related to the audio input has been made, and repeats the process in S605 upon determining that the non-selection operation input related to the audio input has not been made. When a predetermined timeout period elapses without the non-selection operation input, the management unit 105 decrements the friendship degree and ends the friendship degree change processing.

In S606, the control unit 101 determines whether the communication type in the second phase is the “caressing mode”. The control unit 101 advances the processing to S607 upon determining that the communication type in the second phase is the “caressing mode” and advances the processing to S610 upon determining that the type is the “listening mode.”

In S607, the control unit 101 determines whether the non-selection operation input of a type determined in advance for the “caressing mode” has been made. The control unit 101 advances the processing to S608 upon determining that the non-selection operation input of the type determined in advance has been made, and advances the processing to S609 upon determining that such an input has not been made.

In S608, the management unit 105 changes the friendship degree of the target character in accordance with the type of the non-selection operation input made in S607 under the control by the control unit 101. The friendship degree is changed based on a mode of change on the friendship degree determined for each type.

In S609, the control unit 101 determines whether the communication mode has ended. The communication mode may end in response to an operation input on the operation member 134, for example. The control unit 101 ends the friendship degree change processing upon determining that the communication mode has ended, and returns the processing to S607 upon determining that the communication mode has not ended yet.

Upon determining that the communication type related to the second phase is the “listening mode” in S606, the control unit 101 determines whether the number of steps that is a count target in the history of the motion input satisfies a condition related to the message presentation in S610. The control unit 101 advances the processing to S611 upon determining that the number of steps satisfies the condition related to the message presentation, and ends the friendship degree change processing upon determining that the condition is not satisfied.

In S611, the management unit 105 changes the friendship degree of the target character in accordance with the number of steps defining the count target, and ends the friendship degree change processing under the control by the control unit 101. The friendship degree may be incrementally changed by a predetermined value when a favorable selection item is selected through the selection operation input, for example. In this process, the display control is performed on the target character to present a message corresponding to the number of steps that is the count target, but a detailed description on this process will be omitted in the friendship degree change processing.

Upon determining that the change processing has started based on the processing regarding the occurrence of a time designated event in S601, the control unit 101 determines whether the non-selection operation input of a type determined to be favorable for the event has been made within a predetermined period in S612. The control unit 101 advances the processing to S613 upon determining that the non-selection operation input of the type determined to be favorable for the event has been made within the predetermined period, and ends the friendship degree change processing upon determining that such an input has not been made.

In S613, the control unit 101 determines whether a condition (falling asleep or waking up, for example) for ending the time designated event based on the non-selection operation input made in S612 is satisfied. The determination in this step may be made based on random selection, for example. The control unit 101 advances the processing to S614 upon determining that the condition for ending the time designated event is satisfied, and returns the processing to S612 upon determining that the condition is not satisfied.

In S614, the management unit 105 changes the friendship degree of the target character based on achievement of the time designated event, and ends the friendship degree change processing under the control by the control unit 101. The friendship degree may be changed to be incremented by a predetermined value.

As described above, with the game device of this embodiment, a raising game can be provided that enables a character to be raised using an intuitive operation input.

In this embodiment, the friendship degree change processing is triggered by processing requiring the selection operation input or the non-selection operation input. However, it is a matter of course that the modes of change in the friendship degree are not limited thereto. Specifically, the friendship degree may be changed at a time not requiring an operation input from the user, in accordance with a factor (environment or hunger) such as that involving a change over time in the raising game. Thus, the change in the friendship degree in the friendship degree change processing illustrated in FIG. 6 is of a mode limited to the requirement for the operation input related to the raising, and other modes of change may be included.

In this embodiment, a mode is described in which the parameter “friendship degree” is introduced, and the target character's growing state that results from a change in the raising phase (after satisfaction of conditions for changing the raising phase) is determined based on the friendship degree. However, embodiments of the present invention are not limited thereto. Specifically, the present invention encompasses any embodiment in which satisfaction of a condition for changing from the first raising phase to the second raising phase results in selection of one of a plurality of branched growing states of the target character related to the second raising phase based on the raising performed during the first raising phase (prior to satisfaction of the condition for changing) without managing a certain parameter changed based on the history of the operation input. Implementation and usage of the user input provided during the first raising phase (prior to satisfaction of the condition for changing) is provided by storing historical data reflecting the user input (e.g., interaction with an input interface) that was provided during the first raising phase. This historical data is then utilized and compared against various criteria/parameters for determining which of the branched plurality of growing states are to be selected for the character. For example, historical data reflecting a first combination of user inputs provided via an input interface during the first raising phase (e.g., a first operation input not involving selection of a selection item related to the raising) may result in a change along a first growing state based on appropriate criteria/first parameter, whereas historical data reflecting a second combination of user inputs provided via the input interface during the first raising phase (e.g., a first operation input involving selection of a selection item related to the raising) may result in a change along a second growing state based on appropriate criteria/second parameter.

[Other Embodiments]

The present invention is not limited to the above-described embodiments, and various changes and modifications can be made within the scope of the gist of the present invention without departing from the spirit and scope of the present invention. Further, the game device according to the present invention can be implemented as a program that causes one or more computers to function as the game device. This program can be recorded to a computer-readable recording medium and provided or distributed, or can be provided or distributed via a telecommunication line.

### REFERENCE SIGNS LIST

100: game device, 101: control unit, 102: recording medium, 103: memory, 104: element DB, 105: management unit, 106: presentation control unit, 107: operation input unit, 108: communication unit, 110: display unit, 120: audio output unit, 131: touch panel sensor, 132: audio input unit, 133: motion sensor, 134: operation member

What is claimed is:

1. A game device configured to execute processing related to a raising game in which a game element matures, the raising game having a plurality of raising phases defined for the game element, the raising phases defining branches for directing the game element into different growing states, the game device configured to:
execute processing related to the raising game via an executing unit executing via a processor of the game device;
display the game element via a displaying unit;
accept an operation input, provided via an input interface, related to raising of the game element;
manage, via a managing unit executing via the processor of the game device, the raising phases of the game element; and
determine, via the processor of the game device, when a condition for changing from a first raising phase to a second raising phase in the raising game is satisfied, one of branched growing states of the game element related to the second raising phase, in accordance with at least one operation input provided via the input interface prior to satisfaction of the change condition, wherein
the operation input provided via the input interface prior to satisfaction of the change condition comprises a first operation input not involving selection of a selection item related to the raising.

2. The game device according to claim 1, wherein the operation input related to the raising includes a second operation input involving selection of a selection item related to the raising.

3. The game device according to claim 2, wherein the processor is further configured to:
manage a predetermined parameter changing in accordance with the operation input related to the raising, and
determine the one growing state based on the predetermined parameter.

4. The game device according to claim 3, wherein
a change in the predetermined parameter caused by the second operation input varies depending on which growing state the game element is in, whereas
a change in the predetermined parameter caused by the first operation input is same regardless of the growing state of the game element.

5. The game device according to claim 3, wherein
while the raising game is in progress,
a number of times the first operation input is acceptable is not set, whereas
a number of times the second operation input is acceptable is set.

6. The game device according to claim 3, wherein the processor is further configured to enact transition to a predetermined mode in the raising game, wherein
the input interface performs control to enable acceptance of the first operation input in a period during the transition to the predetermined mode.

7. The game device according to claim 6, wherein the displaying unit displays different effects depending on the predetermined parameter, during the transition to the predetermined mode.

8. The game device according to claim 6, wherein
a plurality of types of the first operation input are provided, and
the input interface increases the types of the first operation input acceptable, as the game element proceeds through the raising phases.

9. The game device according to claim 8, wherein
the first operation input includes an audio input, and
the input interface performs control, when the audio input is accepted as the first operation input during the transition to the predetermined mode, to enable acceptance of the first operation input of a different type.

10. The game device according to claim 9, wherein
the first operation input includes a touch input on the displaying unit, and
when the audio input is accepted as the first operation input during the transition to the predetermined mode, the displaying unit changes display of the game element to display corresponding to the touch input.

11. The game device according to claim 8, wherein
the first operation input includes a motion input performed while carrying the game device, and
the displaying unit displays the game element in a mode corresponding to a history of the motion input.

12. The game device according to claim 6, wherein the input interface performs control to enable acceptance of the first operation input when the raising game progresses to a predetermined timing.

13. The game device according to claim 12, wherein the predetermined timing is set as a time point on a clock set for the game device.

14. The game device according to claim 12, wherein the processor enacts a change in the predetermined parameter, caused by the same first operation input, different between a period of transition to the predetermined mode and the predetermined timing.

15. The game device according to claim 3, wherein the input unit performs control to disable acceptance of the first operation input, when a state where the predetermined parameter falls below a threshold continues for a predetermined period of time.

16. The game device according to claim 3, wherein the determining unit determines the one growing state based on a parameter different from the predetermined parameter when the second raising phase is a predetermined raising state or after.

17. The game device according to claim 3, wherein the displaying unit displays a special effect when the predetermined parameter is in a maximum state, in each of the raising phases.

18. The game device according to claim 17, wherein
the special effect includes giving a predetermined item in the raising game,
the raising game is provided with a plurality of types of the game elements raisable, and
the predetermined item given differs among the types of the game elements being raised.
